(19) United States
(12) Patent Application Publication
(10) Pub. No.: US 2013/0272713 A1
(43) Pub. Date: Oct. 17, 2013

(54) SIGNAL PROCESSING CIRCUIT

(71) Applicants: LU-QING MENG, Shenzhen City (CN); HSING-SUANG KAO, Tu-Cheng (TW)

(72) Inventors: LU-QING MENG, Shenzhen City (CN); HSING-SUANG KAO, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/598,647

(22) Filed: Aug. 30, 2012

(30) Foreign Application Priority Data
Apr. 12, 2012 (CN) 201210105276.7

(51) Int. Cl. H04B 10/02

(52) U.S. Cl. 398/106

(57) ABSTRACT

A signal processing circuit includes an infrared signal processing circuit, a button signal processing circuit, and an MCU. The infrared signal processing circuit includes an infrared receiver. The button signal processing circuit includes a first button and at least one second button. The MCU includes a power input port, an infrared signal detecting port, and at least one button signal detecting port. A first terminal of the infrared receiver and a first terminal of the first button are connected to the infrared signal detecting port. A first terminal of the at least one second button is connected to the power input port via a first resistor, and further connected to the at least one button signal detecting port, a second terminal of the first button and a second terminal of the at least one second button are grounded. Thus a more effective infrared detector is available.

### BACKGROUND

1. Technical Field

The present disclosure relates to a signal processing circuit.

2. Description of the Related Art

An electronic device, having an infrared remote control and buttons may include an infrared signal processing circuit and an independent button signal processing circuit. This may result in a low efficiency at a maximum cost. FIG. 1 illustrates a signal processing circuit 10 of related art. The signal processing circuit 10 includes a remote control signal processing circuit 11, a button signal processing circuit 12, and a MCU 13. The MCU 13 includes a power input port VCC1, an infrared signal detecting port IR1, a first button signal detecting port KEY11, a second button signal detecting port KEY12, and a third button signal detecting port SDA/KEY13. The remote control signal processing circuit 11 includes an infrared receiver 110. A first port of the infrared receiver 110 is connected to the infrared signal detecting port IR1 via a resistor R1 and an induction L1. The button signal processing circuit 12 includes a power button POWER1, a stop button STOP1, a power on/off button OPEN/CLOSE1, and a play button PLAY1. A first terminal of the power button POWER1 is connected to the first button signal detecting port KEY11 via an inductor L2. A first terminal of the stop button STOP1 and a first terminal of the power on/off button OPEN/CLOSE1 are connected to the second button signal detecting port KEY12 via an inductor L3. A second terminal of the stop button STOP1 is connected to the first terminal of the power button POWER1. A first terminal of the stop button PLAY1 is connected to the third button signal detecting port SDA/KEY1. A second terminal of the power button POWER1, a second terminal of the power on/off button OPEN/CLOSE1, and a second terminal of the play button PLAY11 are grounded. The first terminal of the power button POWER1 is connected to the power input port Vin1 via a resistor R4. The first terminal of the stop button STOP1 and the first terminal of the power on/off button OPEN/CLOSE1 are connected to the power input port Vin1 via the resistor R3. The first terminal of the play button PLAY1 is connected to the power input port Vin1 via the resistor R2. When the infrared receiver 110 receives an infrared signal transmitted by a remote control, the infrared receiver 110 converts and outputs the infrared signal to the MCU 13 via the infrared signal detecting port IR1. The MCU 13 executes corresponding function in response to the infrared signal.

### BRIEF DESCRIPTION OF THE DRAWINGS

The components in the drawings are not necessarily drawn to scale, the emphasis instead being placed upon clearly illustrating the principles of the disclosure. Moreover, in the drawing, like reference numerals designate corresponding parts throughout the several views.

FIG. 1 is a circuit diagram of a signal processing circuit of related art.

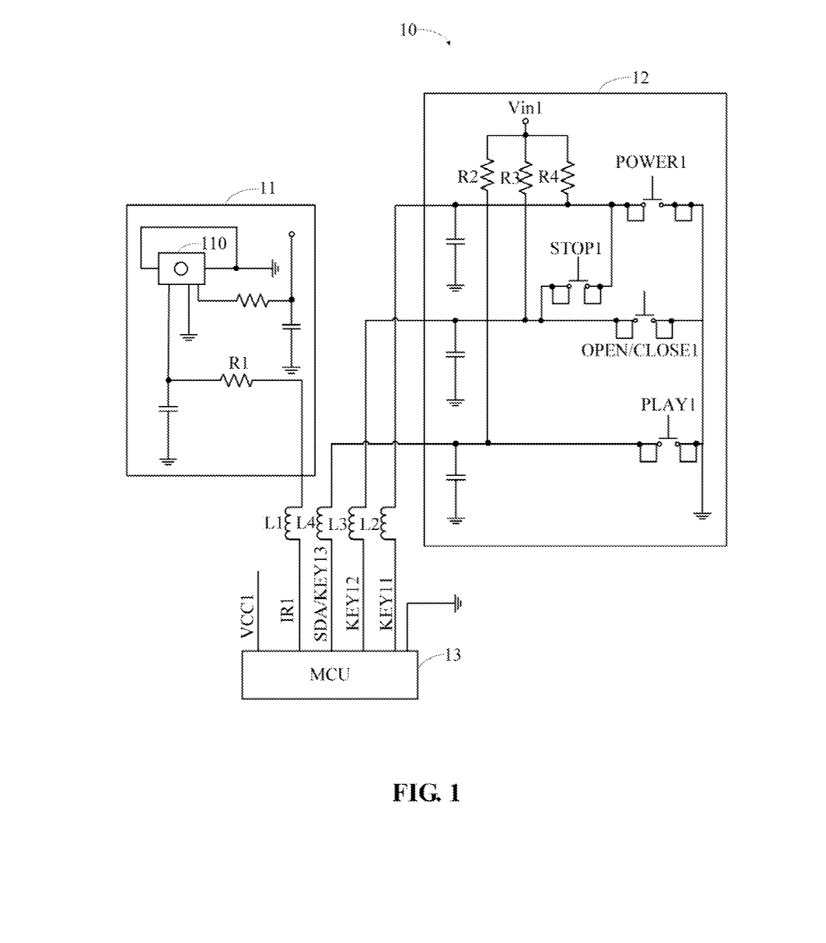

FIG. 2 is a circuit diagram of a signal processing circuit in accordance with an exemplary embodiment.

FIG. 3 is a sequence diagram of the signal processing circuit of FIG. 2 in accordance with an exemplary embodiment.

### DETAILED DESCRIPTION

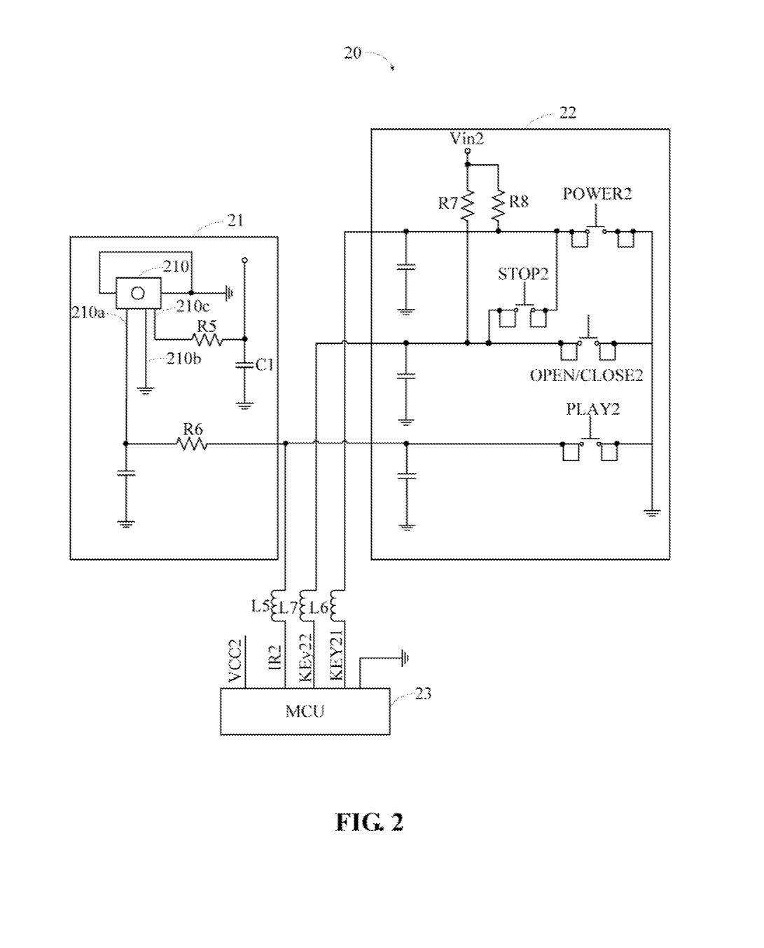

Referring to FIG. 2, a signal processing circuit 20 of an exemplary embodiment is shown. The signal processing circuit 20 is employed in an electronic device having an infrared remote control and a number of mechanical buttons. The signal processing circuit 20 includes an infrared signal processing circuit 21, a button signal processing circuit 22, and a Microprogrammed Control Unit (MCU) 23. The infrared signal processing circuit 21 includes an infrared receiver 210 mounted in the electronic device (not shown) for receiving infrared remote control signal transmitted by a remote control (not shown). In the embodiment, the infrared receiver 210 is an IC (integrated circuit).

The MCU 23 includes a power input port VCC2, an infrared signal detecting port IR2, a first button signal detecting port KEY21, and a second button signal detecting port KEY22. The infrared receiver 210 includes a first port 210a, a second port 210b, and a third port 210c. The first port 210a is connected to the infrared signal detecting port IR2 via a resistor R6 and an inductor L5, the second port 210b is grounded, and the third port 210c is grounded via a resistor R5 and a capacitor C1.

The button signal processing circuit 22 includes a power button POWER2, a stop button STOP2, a power on/off button OPEN/CLOSE2, and a play button PLAY2, mounted on the electronic device. A first terminal of the power button POWER2 is connected to the first button signal detecting port KEY21 via an inductor L6. A first terminal of the stop button STOP2 and a first terminal of the power on/off button OPEN/CLOSE2 are connected to the second button signal detecting port KEY22 via an inductor L7 and a second terminal of the stop button STOP2 is connected to the first terminal of the power button POWER2. A first terminal of the play button PLAY2 is connected to the infrared signal detecting port IR2 via the inductor L5. A second terminal of the power button POWER2, a second terminal of the power on/off button OPEN/CLOSE2 and a second terminal of the play button PLAY2 are grounded. The first terminal of the power button POWER2 is connected to the power input port Vin2, and the first terminal of the stop button STOP2 and the first terminal of the power on/off button OPEN/CLOSE2 are connected to the power input port Vin2 via a resistor R7.

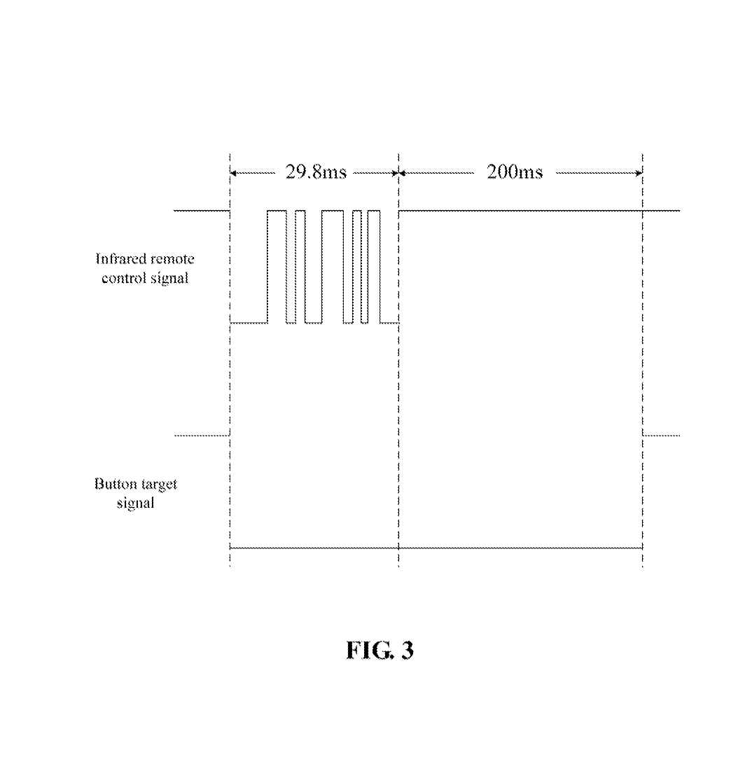

FIG. 3 is a sequence diagram of an infrared remote control signal, which is generated by a remote control (not shown) in response to a user operation on the play button PLAY2. The infrared remote control signal is predefined to be effective during a first predetermined time and invalid during a second predetermined time after the first predetermined time elapses. In the embodiment, the first predetermined time is 29.8 ms and the second predetermined time is 200 ms. A low level signal is generated during the first predetermined time when the play button PLAY2 is pressed by a user. The MCU 23 executes corresponding function in response to the low level. When a low level signal is generated during the second predetermined time, the MCU 23 ignores the low level.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A signal processing circuit comprising:
an infrared signal processing circuit comprising an infrared receiver configured for mounting in an electronic device, the infrared receiver configured for receiving an infrared remote control signal transmitted from a remote control;
a button signal processing circuit comprising a plurality of buttons configured for mounting on the electronic device, wherein the plurality of buttons comprises a first button and at least one second button; and
an MCU comprising a power input port, an infrared signal detecting port, and at least one button signal detecting port, wherein a first terminal of the infrared receiver and a first terminal of the first button are connected to the infrared signal detecting port, a first terminal of the at least one second button is connected to the power input port via a first resistor, and further connected to the at least one button signal detecting port, a second terminal of the first button and a second terminal of the at least one second button are grounded.

2. The signal processing as claimed in claim 1, wherein the infrared receiver is an integrated circuit.

3. The signal processing as claimed in claim 1, wherein the infrared receiver comprises a first port, a second port, and a third port, the first port is connected to the infrared signal detecting port via a second resistor and a first inductor, the second port is grounded, and the third port is grounded via a third resistor and a first capacitor.

4. The signal processing as claimed in claim 3, wherein the first terminal of the first button is connected to the infrared signal detecting port via the first inductor, and the first terminal of the at least one second button is connected to the button signal detecting port via the second inductor.

5. The signal processing as claimed in claim 1, wherein the electronic device is a multimedia player, and the first button is a play button, the at least one second button is selected from the group consisting of a power button, a stop button, and a power on-standby button.
